(19) United States
(12) Patent Application Publication
(10) Pub. No.: US 2006/0287925 A1
(43) Pub. Date: Dec. 21, 2006

(54) Automated sales center

(76) Inventors: William Richard Taylor, Thornhill (CA); Richard George Taylor, Aurora, NY (US)

Correspondence Address: SIMPSON & SIMPSON, PLLC, 5555 MAIN STREET, WILLIAMSVILLE, NY, 14221-5406, US

(21) Appl. No.: 10/551,351

(22) PCT Filed: Dec. 22, 2003
(86) PCT No.: PCT/US03/40840

§ 371 Date: Sep. 28, 2005

Related U.S. Application Data
(60) Provisional application No. 60/435,563, filed on Dec. 20, 2002.

(51) Int. Cl. G06Q 30/00

(52) U.S. Cl. 705/26

(57) ABSTRACT

The product information system of the present invention comprises a set of product information pages which comprises a product information page for each product sold within said system at any product sales organization site or available from any product producer within such system. The invention further comprises a set of product producers that comprises each of the product producers within such system that have a means for providing products to said product sales organizations, a set of product sales organizations which comprises each of the product sales organizations within such system that have a means for displaying product information pages at points of sales where such means have product selection means for allowing customers to choose which specific product he customer wants to see the product information page, and an information handling organization where the information-handling organization provides a first correlation list.

### CROSS-REFERENCE TO RELATED APPLICATIONS

This application claims the benefit of U.S. Provisional Patent Application Ser. No. 60/435,563, filed Dec. 20, 2002 (Attorney Docket No. 90470.155702).

### BACKGROUND AND SUMMARY OF THE INVENTION

The present invention relates to a terminal, system and method for displaying the goods of a multiplicity of vendors through a central office. More particularly it refers to an untended-kiosk-based sales system utilizing communication lines through which product information is handled locally by a store location server. Payment for a purchase item, or other financial transaction takes place through one or more separate financial networks accessible through the kiosk.

The growth of the mass-merchandising industry has created problems for manufacturers. These problems have, in turn, been passed on to consumers in the forms of limitations in the breadth of choice in the amount of and quality of goods, and decreasing availability of retail outlets to provide useful product information via salespeople. A single mass merchandiser typically takes the place of many independently-operated stores and cannot develop or train a knowledgeable work force. However, they are constrained to purchase from similarly-organized high volume manufacturers who have an interest in providing customers with useful information. Furthermore, the indirect costs and risks associated with establishing huge inventories of goods remote from their origins adds significantly to the fraction of the sales price paid to the merchandiser as opposed to the manufacturer.

Many attempts have been made to develop a system of automated sales which would eliminate the need for a merchandiser to hire and train knowledgeable salespersons. However, automated sales units do not presently provide customers with useful information or allow manufacturers to distinguish their goods based on product specifications and features. Vending machines are an example of automated sales units which have been part of the economy for many years. Currently this end is also being accomplished through the Internet. The prior art also describes various ordering devices which may function similarly to a cellular phone as a personal computer terminal. These devices usually reside with the purchaser wherever he or she may be. Like the case of the Internet, they cannot easily respect a manufacturers' territorial marketing plan.

Public network sales schemes can offer some of these advantages but suffer from inherent limitations due to the uncertainty of the physical location of the purchaser at the time of purchase. The need for special security precautions exist in some cases because the purchaser's communication set is not under the control of the vendor or vendor's representative. As stated, the location uncertainty limits the scope of possible agreements regarding sales territories and associated pricing and discounting. The Internet is a broadcast medium. For this reason, a product sold generally on the Internet cannot usually be discounted to it lowest retail price because this would likely compromise agreements with merchants in specific localities such as in one part of a city or state where competition requires special price incentives to offset.

Because of the defined physical location of a kiosk that is used, the invention offers special advantages over public network sales. The selection of goods and their prices, and in some cases the terms of payment, can be varied from location to location to suit local needs. Further the information provided to the customers can be offered in a way to remedy the shortcomings of mass-marketing methods, by allowing purchasers to receive information directly supplied by manufacturers but without requiring the manufacturers to maintain sales personnel or handle credit. This allows the manufacturer to tailor their communications with potential customers and thereby establish more effective and controllable marketing.

For the above reasons, the invention provides manufacturers with a lower-cost mechanism for selling their products than previously available and a more effective way of controlling the information provided to potential purchasers. It also may provide consumers with better product information than is presently available in stores, and that is more immediate than would be possible through a broadcast medium such as the Internet. These self-maintenance needs are best served by providing specialized hardware under the control of a supervisory mechanism which might, for instance, be programmed as an object with a variety of reliability and immediately enhancing routines which could be used to oversee the most immediate information being available to the consumer.

There exist several patents which pertain to the concept of remote advertising, marketing and sales and include:

U.S. Pat. No. 4,528,643 teaches a means of automated remote delivery of a product to a point of sale. It is a method whereby an authorized person may order and receive remote-stored pre-recorded material which is converted into a “material object”, e.g. videotape, by re-recording at the point of sale in response to an authorization code. In one embodiment a master unit serves a plurality of slaved reproduction units at various points of sale. The reproduction units order the information to be served through a catalog number which they transmit to the server.

U.S. Pat. No. 4,734,858 teaches a specialized data terminal for authorized users and a method for placing orders using it. It is a handholdable data terminal containing a keyboard for transmission of orders to a remote computer. Because of the limited interaction possible with the central computer, order reversal and cancellation are a priority. Credit verification is accomplished through the remote computer accessing a credit database.

U.S. Pat. No. 4,797,818 teaches a computerized order delivery system for the food industry the function of which is to select automatically the appropriate store to prepare the food. It is not a consumer purchasing system but appears to be the first computer-based remote order-taking system in the patent literature which emphasizes vendor selection.

U.S. Pat. No. 4,947,028 teaches a portable order placing system which receives information about products/services to be ordered by means of signals generated by scanning printed or displayed identification codes.

Payment is accomplished by transmitting pre-stored credit card or similar information from the consumer's unit to a central computer. It may be adapted for use by the handicapped.

U.S. Pat. No. 4,982,346 teaches what is essentially a kiosk-based computer apparatus which displays advertising, dispenses coupons and takes orders via a touch screen and credit card reader. It is intended to be placed in a mall to serve promotional campaigns for specific goods.

U.S. Pat. No. 4,992,940 teaches an automated system for the purchase of goods by a plurality of vendors. It comprises a computer and a database. The purchaser selects the goods from the database and the system places the order. It is basically an automated catalog.

U.S. Pat. No. 5,047,613 teaches an arrangement for the purchase and dispensing of goods by means of an automated teller machine. Payment is handled through the automatic teller via an electronic financial network.

U.S. Pat. No. 5,256,863 teaches a networked purchasing system for use by consumers in stores. The system is limited to a local area network within the store.

U.S. Pat. No. 5,289,371 teaches a networked purchasing system which reciprocally links stores such that each may function as an order generator or as a vendor/deliverer. This networked purchasing system is primarily oriented to the sale of remotely-delivered flowers and is not envisioned as something directly used by customers.

U.S. Pat. No. 5,311,423 teaches a method of the networked sale of video performances. It includes means for the remote display of video performances via a video server. It is intended to be used by store employees rather than by customers and like U.S. Pat. No. 4,528,643, incorporates a means for generating media copies.

U.S. Pat. No. 5,315,508 teaches a method of processing purchase requests from a multiplicity of separate sources. It primarily effects the handling, packing and shipping aspects of purchases made over a network.

U.S. Pat. No. 5,305,195 teaches a method of integrating digital advertising into a network of remotely-located kiosk-type terminals. It is limited to the interlacing of the advertisement with some other typically unrelated service the terminals otherwise perform. It does not address the issue of purchasing the advertised goods through the terminal.

U.S. Pat. No. 5,336,870 teaches of a personal ordering and payment terminal and method for remote point of sale transactions. It is similar to that described in U.S. Pat. No. 4,734,858 but has augmented security functions and a credit/debit card reader. It is not intended to have a fixed place of operation and is described only as a payment device. It is further defined as “a unitary terminal having a top surface” and “a QWERTY keyboard”.

U.S. Pat. No. 5,440,479 teaches a kiosk-based remote purchasing system and method. Although the kiosk is fixed in location, the patent does not exploit that fact. The kiosk and its associated method are expressly offered as an augmentation of the existing floral network mentioned in U.S. Pat. No. 5,289,371 and others which follow. It is defined by the statement “having stored data representing floral arrangements” as a function of the kiosk.

U.S. Pat. No. 5,594,786 teaches of a local area network of terminals having reciprocal sight and sound capability which can be used to request goods and services within a hospital. It is the only specific reference found to a networked “multimedia” order handling system in the patent literature.

U.S. Pat. No. 5,595,263 teaches a merchandising means and method. The customer orders the merchandise at networked ordering terminals or kiosks using a visual screen and a selector means. However, the networking is described as essentially local since the terminals are located within the store. A defining feature of the invention is “a plurality of robots” which are activated as a consequence of the order being placed.

U.S. Pat. No. 5,619,024 teaches an unmanned sales system and method for access to computer and copy equipment using a local area network tying into a separate financial network. It includes a supervisory function to verify that the equipment is operational and to schedule jobs in a queue. It is defined using the term, “a vending machine”.

U.S. Pat. No. 5,637,845 teaches a means of encoding and dispensing, such as at an unattended kiosk, prepaid cards using an external financial network.

U.S. Pat. No. 5,664,110 teaches a means of remote catalog ordering through a network or telephone line using a personal ordering device.

U.S. Pat. No. 5,692,132 illustrates the conventional contextual definition of “computer network” as “public computer network”

U.S. Pat. No. 5,699,528 teaches an alternative to card methods for the electronic payment of bills as when making an electronic purchase. The method utilizes an Internet credit server.

U.S. Pat. No. 5,715,314 teaches a networked sales system linking one or more buyer computers with a merchant computer.

U.S. Pat. No. 5,724,424 teaches a networked sales system linking a plurality of merchant and buyer computers over a public packet switched communications network. It describes the use of digital advertising and means for maintaining security on a public network.

### SUMMARY

The invention provides an unmanned sales kiosk for use by consumers as a reduced overhead substitute for a knowledgeable and trained sales staff. The unmanned sales kiosk provides manufacturers controlled product or service information in a specific fixed location. The invention provides ready access for the prospective purchaser to in-depth multimedia presentations on the characteristics, advantages and cautions associated with particular products, and provides the manufacturer control over the information provided to prospective customers at points of sale.

The invention provides a plurality of sales centers each having products, product descriptions and prices suited to their specific locale.

According to one aspect of the present invention a system for providing product information to consumers comprises the following components: A kiosk containing a data terminal having: a visual display; a selector for indicating a choice of products or responses; and, a product information server located in each retail outlet. A central product information handling master unit including a computer. A communications line providing a connection between the retail unit and the master unit. The central master unit computer having a database containing products and their prices stored in a manner so as to be uniquely identified at the kiosk as a means for sending product information from the retail outlet to be displayed at the kiosk function of the kiosk's physical location. A “dedicated communications line” is preferred according to the invention. A similar line is offered by various long distance carriers for business use, transmitting information in relatively rapid manner typically using a satellite based communications system. Examples of a “dedicated communications line” include a dedicated ISDN line, or a conventional phone line which “calls up” a dedicated line.

The system may further comprise a printer for printing of customer requested information, located at the kiosk. A supervisory control preferably cooperates with the master unit to monitor the kiosk's integrity and functionality.

According to another aspect of the present invention a merchandising system is provided comprising the following components:

A plurality of kiosks, each containing an order terminal, the kiosks placed at fixed geographic locations. Each kiosk including a system comprising: a microprocessor; memory to temporarily store data; a display screen for displaying information to a customer; a selector device which allows selection of choices; a credit/identification system including a credit/debit card reader; an advertising display visible to the public; and a printer for customer receipts and papers Each will also a connection from each kiosk to a local central server unit; a communications line (e.g. a private communications line) connecting each the kiosk to the central master unit; and, the central master unit including a server computer. The master unit will have a database of products and their prices stored in a manner so as to be correctly identified and displayed at the kiosk as a function of each the kiosk's physical location for purchasing use at that location only, and a customer database having the names and addresses of customers.

The system may further comprise a vendor's order desk for the issuance of purchase messages to a plurality of vendors. The order desk is operatively connected to the master unit. The product database may be augmented with references allowing calls to be made to a video storage device holding advertising and customer service information transmissible to a selected kiosk display screen. The video storage device may be augmented with sound recordings transmissible to a selected kiosk and reproduced through speakers incorporated into the kiosk; and there may further be a video camera in each kiosk to monitor customer transactions.

According to another aspect of the present invention, there is provided a method of merchandising in which a customer views product information using an unmanned terminal in the form of a fixed-location kiosk attached by a private communications link to a store location server which commands many such kiosks, each kiosk including a display screen, the method comprises the steps of: (a) Displaying advertising messages at the kiosk. (b) Displaying a menu of choices on the display screen, including goods that may be selected. (c) In response to customer input, transmitting customer selections to the master unit. (d) Providing the customer with a tangible form of the product information which might also include a unique product identification.

Step (d) may be practiced in part by printing a receipt at the kiosk. Step (c) may be practiced in part by the customer touching the display screen to input selection data, and using a private communications line. There may be the further step of, by computer, conducting security checks on the operation of the kiosk. There may also be the further step of, in response to customer input, providing audio and/or visual information about goods through the display screen and/or speakers in the kiosk. Step (a) may be practiced by displaying the changing video images on a second video screen remote from the display screen.

### BRIEF DESCRIPTION OF THE DRAWINGS

FIG. 1 is a schematic representation of the product information system of the present application.

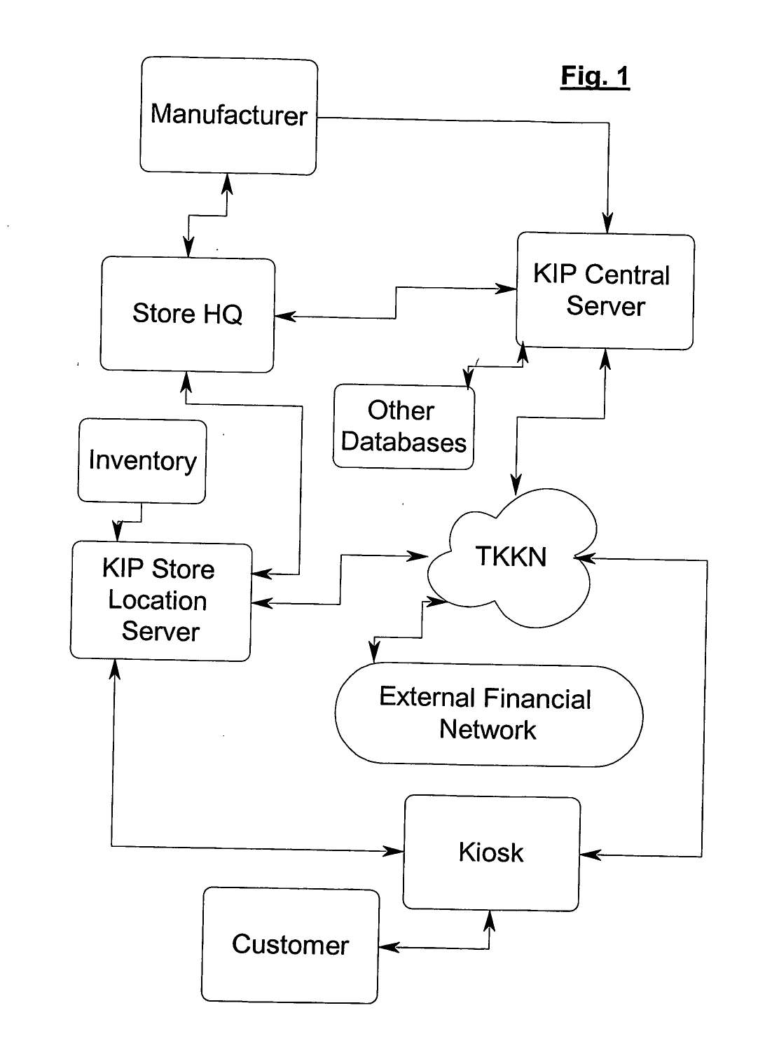

FIG. 2 is a schematic representation of the method of using the present system to access product or service information when chosen from a menu driven selection means.

FIG. 3 is a schematic representation of the method and apparatus employing a product identification means.

FIG. 4 is a schematic representation of the operational architecture of the invention.

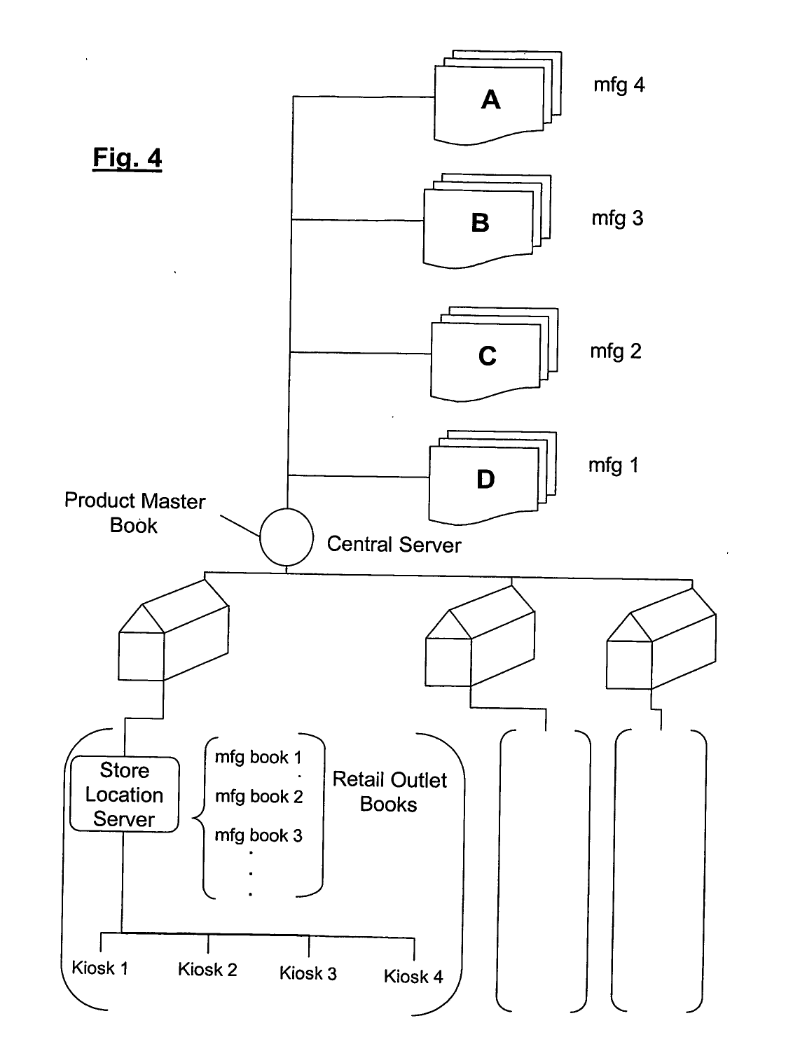

### DETAILED DESCRIPTION

The present invention provides a system for providing information to customers at retail locations. Information is provided through a kiosk located at a retail outlet, that has information concerning each product, item or service provided through such outlets. At a particular retail outlet, a customer can use the kiosk to identify a particular product within the retail outlet, and to view a manufacturer designed presentation about the product. This presentation may include the specifications of the product and any particular special pricing program or initiative at the retail outlet.

Each retail outlet will have a local server that maintains a collection of product pages for each product or service available through the store. A particular kiosk will have a broad band link to the local server, means to select the proper unique product or service code, means to transmit the code to the local server and means to display the product page on said kiosk. The broad band link is preferably a Local Area Network (LAN) such as a 10/100BASE-T ethernet network. A gigabit ethernet network may be required for certain applications. Alternatively, a Wireless Local Area Network (WLAN) such as the IEEE 802.11 wireless standards may be used to network the kiosks to the store location server.

The local server will have a list of the unique product codes coordinated with the book of product pages for the retail outlet. This book will comprise the manufacturer or provider authored information for each product or service, and can be updated automatically from a master central server. The pages of the local book are downloaded to the kiosk upon selection by a potential customer.

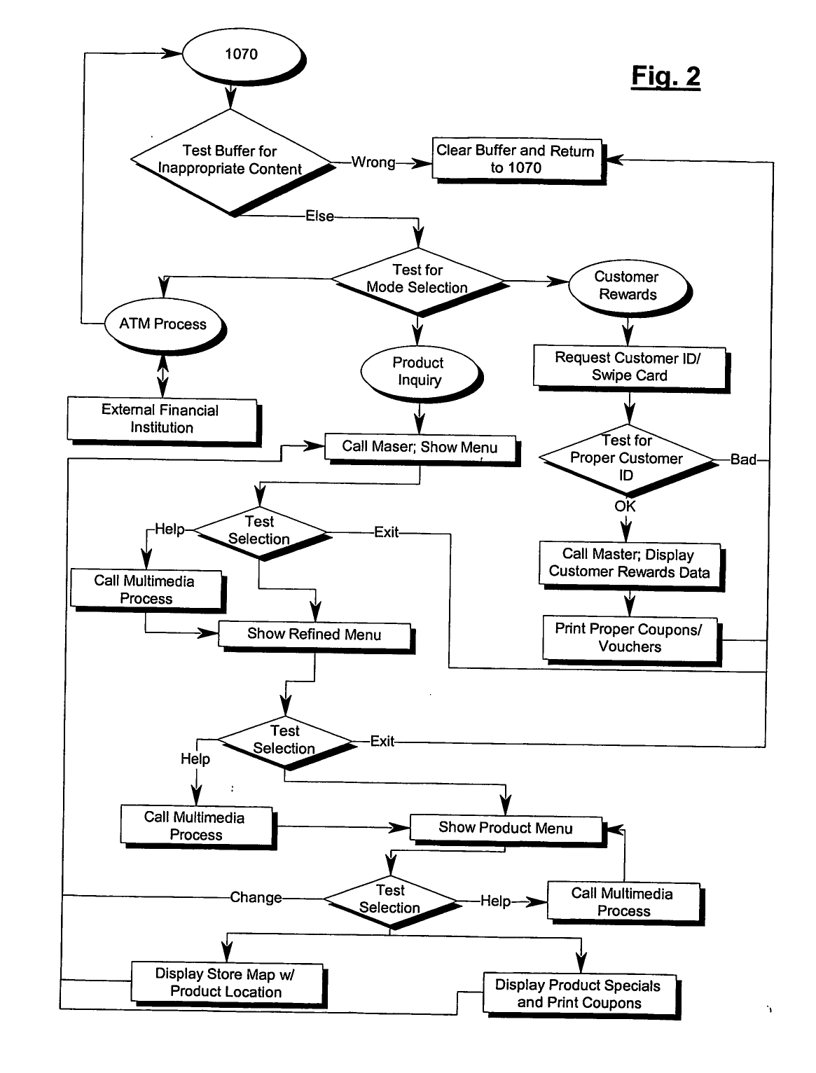

The invention comprises a method and system for providing product information through an automated kiosk which includes a mechanism for updating product information and providing such information to customers on a real-time basis. The customer interacts through a kiosk as shown in FIGS. 2a and 2b. The kiosk preferably comprises or consists of a display screen, product selection means and a broad-band feed from a store location server. The prospective purchaser may be attracted by an advertisement in the form of a broadside viewing screen showing a picture, or sequence of pictures, in the kiosk's frame buffer while the kiosk is unused. The customer may activate the kiosk components through a touch screen or other input means which then displays a catalog menu. The customer may select a category of goods from the menu and then proceed through a logical tree of menu selections toward the desired product. Pictures (preferably photos) of products are individually (or in groups) displayed and suggestions may be offered on the screen. Selection may be effected by touching the screen (if a conventional “touch” type). In addition to, or as an alternate to, the touch screen, any type of conventional push button or like controls may be used.

Alternately, an automated product recognition device may be used that will scan an item brought to the kiosk, identify the product and then display the manufacturers description and explanation of the product or service on the kiosk's display screen.

Upon selecting a particular product for sale the potential purchaser will be shown a description of the product or service that may include an in-depth multimedia sales description in the form of moving pictures or images displayed on screen while sound is heard through speakers or a headset. If the customer wishes to purchase an item, he/she may so indicate and return to the menu to select further items. When all items are selected the customer may view a table of items selected on the screen and approve his/her selections individually.

Product information for each store location is located on a server at the store. This store location server is linked to each kiosk at the sales site by a broad-band local line that allows each kiosk to play the multimedia product page for each product or service sold at that store. Thus for each item in the store inventory there is an entry that can be synchronized with the headquarters of the store chain, and with a central server. The store location server handles only the product pages for items in the store and updates such pages by synchronizing with the central server. In operation a customer would select a product that they wanted more information about at the kiosk. The kiosk would then take the unique product code and download the product page from the store location server. In the event that the product was not listed on the store location server, an inquiry would be sent to the central server, and the file would be downloaded to the store location server, and then sent to the kiosk to be displayed to the customer.

In the event that the central server did not have a product page for the item requested at a kiosk, the central server could query a participating manufacturer server for an updated page, or generate an error message. Similarly, the system could have a means for determining whether the store head-quarters had authorized such an item to be in the store location inventory, and if so then require the manufacturer to provide a product page to the central server.

The kiosk may also include a link to an outside financial services network to allow financial transactions to be undertaken on the system.

Functional features of the kiosk terminal are schematically shown in FIGS. 2a and 2b. The architecture of the terminal follows that of typical personal computer, including a microprocessor, a high speed link to the store location server, a basic operating system and boot program are contained on read only memory, an input means and a display means. This is sufficient memory to allow the terminal to receive a message from the master unit through communications line and a display means. An initial message loads an operating program into memory along with advertisement images into the screen buffers. The major advertising message may be displayed on broadside display. A welcoming screen with start options is displayed on the screen.

At intervals a supervisory program preferably tests the operability of the components including the physical integrity of the kiosk.

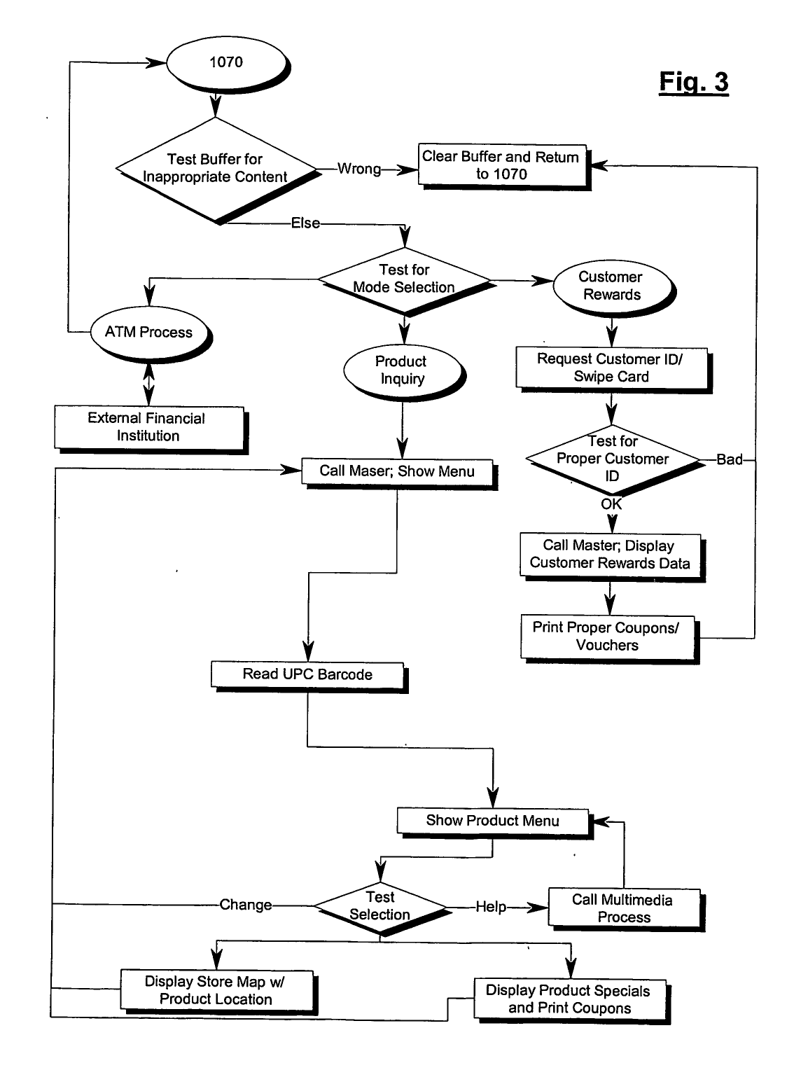

FIG. 3 is schematic representation of the architecture of the present unmanned sales system showing a plurality of manufacturers that provide the individual product pages for each of their products, a central server that collects all of the product pages for each unique product, and the plurality of store location site servers that download and form product books for the collection of products and services sold within that store.

Synchronization of the store location books with updated product manufacturer pages on an automated basis allow a manufacturer to update their sales information and materials by directing it to one centralized server rather than place it at each retail outlet. It also allows each retail outlet to provide more information to their customers than would be available through the use of their sales staff. Furthermore, the system can also allow each retail store to upload sales incentives and programs to the central server.

There may be any number of stages of refinement. For instance in the matter of selecting a product that a customer wants further information about the general menu might look like the directory of the retail store. For example the customer selects “housewares”. The refined menu contains headings for different categories of housewares such as “cookware”, “small appliances.” and so forth. If the customer chooses “small appliances” seeking a toaster, there would be another level of refinement since there are too many different toasters to include on merely one page of “small appliances”.

The customer may actually select a product, e.g. a particular toaster, in that case, the product's designation code is added to a list in the kiosk and sent to the local store server. The server responds with the product information page. If the customer is finished browsing and wishes to purchase that option is selected; the purchase routine is then exited and a payment process is begun.

The present invention provides a system for providing information to customers at retail locations. Information is provided through a kiosk located at a retail outlet that has information concerning each product, item or service provided through such outlets. At a particular retail outlet, a customer can use the kiosk to identify a particular product within the retail outlet, and to view a manufacturer designed presentation about the product. This presentation may include the specifications of the product and any particular special pricing program or initiative at the retail outlet.

Each retail outlet will have a local server that maintains a collection of product pages for each product or service available through the store. A particular kiosk will have a broad band link to the local server, means to select the proper unique product or service code, means to transmit the code to the local server and means to display the product page on said kiosk. The local server will have a list of the unique product codes coordinated with the book of product pages for the retail outlet. This book will comprise the manufacturer or provider authored information for each product or service, and can be updated automatically from a master central server. The pages of the local book are downloaded to the individual store server so that retrieval of the full page by a user at a kiosk is quick enough so that a use will not feed delayed.

### Multiple Applications

The kiosk of the present application comprises a display, a user input and a connection to a server to provide at least one sales application. Such applications may include the provision of sales information, the sale of services, insurance, reservations, financial information services and the like. Thus the kiosk of the present invention can have the capability of providing a customer with at lest two commercial applications, such as product information and a financial service (a bank balance inquiry). Any two commercial applications may be available on the kiosk, and in another example renting a car and making a hotel reservation may be the choice of services at an automobile rental facility where the kiosk is located.

### Alternate Information Technology Architectures

Besides an overall system architecture where product information is provided by a manufacturer to a central sales server and then distributed to sales location server and then to kiosk in response to a product information request, the system can operate with a central location server that is provided with high speed lines to each kiosk. In such cases a sales location book for the location at which the kiosk is located would reside within the central location server and would be transmitted over the high speed line to the kiosk upon receipt of a product information request.

In such decentralized architectures the kiosks may be provided with more than one customer accessible “application.” The kiosk may also have the capability of running more than a given application software, and access to each of the additional applications allows a user to select different product or service databases from a specific point-of-sale location.

### Conclusion

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for providing contemporaneous product information to a customer at retail sales locations comprising the steps of:
directing product sources to create and supply product pages formatted to a defined data-form specification;
maintaining the product pages on a central location server where each product page is identified with a unique code identifier;
providing a specific sales location server with a site location product list;
synchronizing the site location product list with the central location server to create a download list on said central location server specific to said retail sales location; and
downloading the product pages corresponding to said download list to said retail sales location server.

2. The method of claim 1 wherein said retail location server downloads product pages to a kiosk in response to a product information request from said kiosk.

3. The method of claim 2 wherein the method further comprises the step of choosing a product from a menu driven selection means.

4. The method of claim 2 wherein the method further comprises the step of choosing a product from an automated product identification means.

5. A product information system comprising:
a set of product information pages which comprises a product information page for each product sold within said system at any product sales organization site or available from any product producer within such system;
a set of product producers that comprises each of the product producers within such system that have a means for providing products to said product sales organizations;
a set of product sales organizations which comprises each of the product sales organizations within such system that have a means for displaying product information pages at points of sales where such means have product selection means for allowing customers to choose which specific product he customer wants to see the product information page; and
an information handling organization where said information-handling organization provides a first correlation list of product information page to individual product sales organization and a second correlation list correlating product producer with product information pages.

6. The system of claim 5 wherein said information handling organization further comprises means for authoring a product information page that includes means for inputting product information from said individual product producer.

7. The system of claim 6 wherein said information handling organization provides a commission charge to said product producer upon the event of a sale of a specific product at a specific product sales organization.

8. The system of claim 7 wherein said correlates said commission charge to an invoice to said product sales organization.

9. The system of claim 7 wherein said product information pages include a multimedia display that describes the product and its features and which further includes a set of links to related products that may be of interest to a potential customer.

10. The system of claim 9 wherein said information page has navigation means that when coupled with an output means at the product sales site allows a customer to navigate through the information page.

11. The system of claim 5 wherein the means for displaying product information are leased by said information handling organization to said product sales organizations.

12. The system of claim 5 wherein the means for displaying product information are owned by the set of product producers.

13. The system of claim 11 wherein the means for displaying product information are leased by said information handling organization to said product sales organizations wherein said lease price is a portion of sales of products per a defined use schedule.

14. The system of claim 11 wherein the means for displaying product information are leased by said information handling organization to said product sales organizations wherein said lease price is a portion of sales of products.
